(19) United States
(12) Patent Application Publication
(10) Pub. No.: US 2022/0368830 A1
(43) Pub. Date: Nov. 17, 2022

(54) Presence and Location Based Driver Recording System

(71) Applicant: Bendix Commercial Vehicle Systems LLC, Elyria, OH (US)

(72) Inventor: Hans M. MOLIN, Mission Viejo, CA (US)

(21) Appl. No.: 17/317,476

(22) Filed: May 11, 2021

(51) Int. Cl. H04N 5/232; G06T 7/70; H04N 5/76; H04N 7/18

(52) U.S. Cl. CPC H04N 5/23245; G06T 7/70; H04N 5/76; H04N 7/18; G06T 2207/30268; G06T 2207/30196; G07C 5/02

(57) ABSTRACT

A system for recording vehicle occupants and their immediate environment includes a driver-facing camera that has a plurality of recording modes, an input that receives driver-related data, and a processor that determines a driver position based on the detected driver-related data, and alters the recording mode of the driver-facing camera in response to the determined driver position.

### FIELD OF THE INVENTION

The invention relates to adjusting recording modes of driver facing cameras and, in particular, to adjusting recording modes of driver facing cameras in response to identified driver positions, which allows for the recording of driver activity during periods and at levels of detail that minimize the invasion of driver privacy.

### BACKGROUND

Current methods of capturing driving data include capturing video data via one or more driver facing cameras. However, such driver facing cameras have the potential to invade driver privacy, particularly during periods in which recording of the driver is unnecessary. Recording during under these circumstances may lead to an unhappy and resentful driver.

The current approach for limiting the potential intrusion of driver privacy is to manually turn off the driver facing camera. However, aside from the inconvenience of having to manually operate the driver facing camera, this known approach can be overly restrictive. Other systems may automatically turn off the driver facing camera based on detected factors such as time of day, driver duty status, vehicle speed, and the like. However, these systems may not record where desired, and may record where unnecessary.

As such, there is a need in the art for a system and method that overcomes the aforementioned drawbacks.

### SUMMARY OF THE INVENTION

In one embodiment of the invention, a system for recording vehicle occupants and their immediate environment using a driver-facing camera is provided. The system includes the driver-facing camera, which has a plurality of recording modes. The plurality of recording modes includes a normal recording mode, in which video data is recorded to a memory, and at least one obscured recording mode, in which the video data is partially or wholly obscured, or is otherwise not recorded to the memory. The system also includes an input that receives driver-data from one or more sensors, from which driver-related data a driver position can be identified. The system also includes a processor that determines a recording-mode-changing event based on the detected driver-related data, and more particularly based on the identified driver position. The processor is also configured to alter the recording mode of the driver-facing camera in response to determining the recording-mode-changing event, particularly to switch between normal and obscured recording modes based thereon.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a block diagram that illustrates a vehicle-based computer system configured to implement one or more aspects of the invention;

FIG. 2 is a schematic diagram of a driver-facing camera system according to one or more aspects of the invention;

FIG. 3 illustrates an exemplary process for implementing one or more aspects of the invention.

### DESCRIPTION OF EXEMPLARY EMBODIMENTS OF THE INVENTION

In the following description of the present invention reference is made to the accompanying figures which form a part thereof, and in which is shown, by way of illustration, exemplary embodiments illustrating the principles of the present invention and how it is practiced. Other embodiments can be utilized to practice the present invention and structural and functional changes can be made thereto without departing from the scope of the present invention

In certain embodiments, the invention may be implemented by an on-vehicle event detection and reporting system that may include one or more driver facing cameras that are configured such that the field of view of the camera(s) captures a view the driver of the vehicle, and/or a view of other areas of the cabin, such as the driver controls of the vehicle while driving and non-driver passenger areas. Still other embodiments may include cameras configured to capture other scenes relative to the vehicle. For instance, embodiments may include cameras configured to capture the scene in front of the vehicle, behind the vehicle, to either side of the vehicle, etc.

The event detection and reporting system may be further configured to collect and provide non-video data, including non-video event-based data corresponding to a detected driver or vehicle event that occurred at a particular point in time during a driving excursion. Such event-based data can include data collected from components of, or components interacting with, the event detection and reporting system.

These components can detect, in real time, driver or vehicle-related events that happen over the course of a driving excursion, or even outside of the driving excursion. The components can report such events to the detection and reporting system. Examples of events that may be detected and/or reported to/collected by the event detection and reporting system in real time include safety events, for example and without limitation, excessive acceleration, excessive braking, exceeding speed limit, excessive curve speed, excessive lane departure, lane change without turn signal, loss of video tracking, LDW system warning, following distance alert, forward collision warning, collision mitigation braking, collision occurrence, etc., and non-safety events, for example and without limitation, the driver logging in/out of a vehicle telematics system, the driver/passenger entering/leaving the vehicle, the driver/passenger occupying/vacating the bunk area, the driver occupying/vacating the driver seat, the vehicle engine being on/off, the vehicle gear being in park/drive, the parking brake being on/off, etc. Non-safety events may also include theft events, for example and without limitation, the presence of an unauthorized occupant accessing the vehicle, etc.

In accordance with an embodiment, the event detection and reporting system may use data collected directly from vehicle components (e.g., devices, sensors, or systems), and data collected from an analysis of vehicle video, to generate event datasets that correspond in time with one or more detected events. Event data generated for a detected event may be associated with captured video frames whose timeline spans or overlaps the time when the event was detected/collected. Event data generated from an event determined from processing of captured vehicle video may at least be associated with the video from which it was generated, but may also be associated with other captured video frames whose timelines span or overlap the time when the event was detected/collected (in these scenarios, the time may be calculated based on the video frame or frames from which the event object was derived).

In at least some embodiments, the invention relates to a system and method for adjusting recording modes of the driver facing cameras of such event detection and reporting systems, in response to detected driver position, or more generally to detected positions of vehicle cabin occupants. In certain embodiments, this is achieved by entering a different mode of recording (i.e., recording mode) in response to the detected driver position, which may be, for example location within the cabin (e.g., in-seat versus out-of-seat) and/or attitude (e.g., driver has a target driving posture). This different mode of recording is characterized by the fact that the video data of the driver facing camera is altered in a manner which obscures the recorded image data, in whole or in part, or is otherwise not recorded. One or more techniques for altering video data to obscure recorded image data are disclosed in U.S. application Ser. No. 16/664,626, entitled “System and Method for Adjusting Recording Modes for Driver Facing Cameras,” which is assigned to the assignee hereof, the entire disclosure of which is incorporated herein by reference.

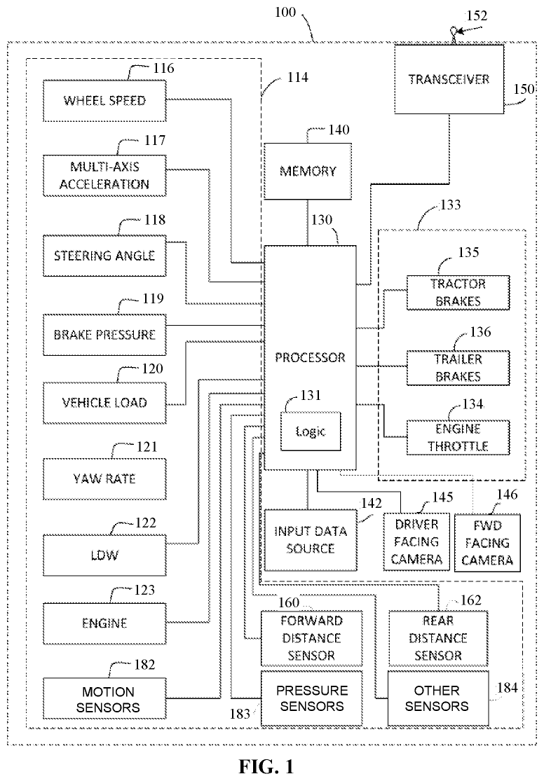

Referring first to FIG. 1, by way of overview a schematic block diagram is provided illustrating details of an event detection and reporting system configured to be used in accordance with one or more exemplary embodiments of the invention. The in-vehicle event detection and reporting system 100 may be adapted to detect a variety of operational parameters and conditions of the vehicle and the driver's interaction therewith and, based thereon, to determine if a driving or vehicle event has occurred (e.g., if one or more operational parameter/condition thresholds has been exceeded). Data related to detected events (i.e., event data) may then be stored and/or transmitted to a remote location/server, as described in more detail below.

The event detection and reporting system 100 of FIG. 1 may include one or more devices or systems 114 for providing vehicle-related and/or driver-related input data indicative of one or more operating parameters or one or more conditions of a commercial vehicle, its surroundings and/or its cabin occupants. Alternatively, the event detection and reporting system 100 may include a signal interface for receiving signals from the one or more devices or systems 114, which may be configured separate from system 100. For example, the devices 114 may be one or more sensors, such as but not limited to, one or more wheel speed sensors 116, one or more acceleration sensors such as multi-axis acceleration sensors 117, a steering angle sensor 118, a brake pressure sensor 119, one or more vehicle load sensors 120, a yaw rate sensor 121, a lane departure warning (LDW) sensor or system 122, one or more engine speed or condition sensors 123, and a tire pressure (TPMS) monitoring system (not shown). The event detection and reporting system 100 may also utilize additional devices or sensors, including for example a forward distance sensor 160 and a rear distance sensor 162 (e.g., radar, lidar, etc.). Additional sensors for capturing driver-related data may include one or more video and/or motion sensors 182 (including driver facing camera 145, as discussed further herein), pressure or proximity sensors 183 located in one or more seats and/or driver controls (e.g., steering wheel, pedals, etc.), or other sensors 184 configured to capture driver-related data. Other sensors, actuators and/or devices or combinations thereof may be used of otherwise provided as well, and one or more devices or sensors may be combined into a single unit as may be necessary and/or desired.

The event detection and reporting system 100 may also include brake light(s) and/or notification devices, which may be usable to provide headway time/safe following distance warnings, lane departure warnings, and warnings relating to braking and or obstacle avoidance events.

The event detection and reporting system 100 may also include a logic applying arrangement such as a controller or processor 130 and control logic 131, in communication with the one or more devices or systems 114. The processor 130 may include one or more inputs for receiving input data from the devices or systems 114. The processor 130 may be adapted to process the input data and compare the raw or processed input data to one or more stored threshold values or desired averages, or to process the input data and compare the raw or processed input data to one or more circumstance-dependent desired value.

The processor 130 may also include one or more outputs for delivering a control signal to one or more vehicle systems 133 based on the comparison. The control signal may instruct the systems 133 to provide one or more types of driver assistance warnings (e.g., warnings relating to braking and or obstacle avoidance events) and/or to intervene in the operation of the vehicle to initiate corrective action. For example, the processor 130 may generate and send the control signal to an engine electronic control unit or an actuating device to reduce the engine throttle 134 and slow the vehicle down. Further, the processor 130 may send the control signal to one or more vehicle brake systems 135, 136 to selectively engage the brakes (e.g., a differential braking operation). A variety of corrective actions may be possible and multiple corrective actions may be initiated at the same time.

The event detection and reporting system 100 may also include a memory portion 140 for storing and accessing system information, such as for example the system control logic 131. The memory portion 140, however, may be separate from the processor 130. The sensors 114 and processor 130 may be part of a preexisting system or use components of a preexisting system.

The event detection and reporting system 100 may also include a source of vehicle-related input data 142 indicative of a configuration/condition of a commercial vehicle. The processor 130 may sense or estimate the configuration/condition of the vehicle based on the input data, and may select a control tuning mode or sensitivity based on the vehicle configuration/condition. The processor 130 may compare the operational data received from the sensors or systems 114 to the information provided by the tuning.

In addition, the event detection and reporting system 100 may be operatively coupled with (or may comprise) one or more driver facing imaging devices, shown in the example embodiment for simplicity and ease of illustration as a single driver facing camera 145 that is trained on the driver and/or trained on the interior of the cab of the commercial vehicle. However, it should be appreciated that one or more physical video cameras may be disposed on the vehicle such as, for example, a video camera on each corner of the vehicle, one or more cameras mounted remotely and in operative communication with the event detection and reporting system 100 such as a forward facing camera 146 to record images of the roadway ahead of the vehicle. In the example embodiments, driver-related data can be collected directly using the driver facing camera 145, such driver data including driver head position, hand position, postural attitude and location, or the like, within the vehicle being operated by the vehicle. In addition, driver identity can be determined based on facial recognition technology and/or body/posture template matching.

In operation, the driver facing camera 145 may video data of the captured image area. The video data may be captured on a continuous basis, or in response to a detected event. Such data may comprise a sequence of video frames with separate but associated sensor data that has been collected from one or more on-vehicle sensors or devices, as detailed herein. As such, the devices or systems 114 for providing vehicle-related and/or driver-related input data may comprise at least the driver facing camera 145.

Still yet further, the event detection and reporting system 100 may also include a transmitter/receiver (transceiver) module 150 such as, for example, a radio frequency (RF) transmitter including one or more antennas 152 for wireless communication of the automated control requests, GPS data, one or more various vehicle configuration and/or condition data, or the like between the vehicles and one or more destinations such as, for example, to one or more services (not shown) having a corresponding receiver and antenna. The transmitter/receiver (transceiver) module 150 may include various functional parts of sub portions operatively coupled with a platoon control unit including for example a communication receiver portion, a global position sensor (GPS) receiver portion, and a communication transmitter. For communication of specific information and/or data, the communication receiver and transmitter portions may include one or more functional and/or operational communication interface portions as well.

The processor 130 is operative to combine selected ones of the collected signals from the sensor systems described herein into processed data representative of higher level vehicle condition data such as, for example, data from the multi-axis acceleration sensors 117 may be combined with the data from the steering angle sensor 118 to determine excessive curve speed event data. Other hybrid event data relatable to the vehicle and driver of the vehicle and obtainable from combining one or more selected raw data items from the sensors includes, for example and without limitation, excessive braking event data, excessive curve speed event data, lane departure warning event data, excessive lane departure event data, lane change without turn signal event data, loss of video tracking event data, LDW system disabled event data, distance alert event data, forward collision warning event data, haptic warning event data, collision mitigation braking event data, ATC event data, ESC event data, RSC event data, ABS event data, TPMS event data, engine system event data, average following distance event data, average fuel consumption event data, average ACC usage event data, and late speed adaptation (such as that given by signage or exiting).

The event detection and reporting system 100 of FIG. 1 is suitable for executing embodiments of one or more software systems or modules that perform or otherwise cause the performance of one or more features and aspects of the event detection and reporting system 100. The example event detection and reporting system 100 may include a bus or other communication mechanism for communicating information, and a processor 130 coupled with the bus for processing information. The computer system includes a main memory 140, such as random access memory (RAM) or other dynamic storage device for storing instructions and loaded portions of the trained neural network to be executed by the processor 130, and read only memory (ROM) or other static storage device for storing other static information and instructions for the processor 130. Other storage devices may also suitably be provided for storing information and instructions as necessary or desired.

Instructions may be read into the main memory 140 from another computer-readable medium, such as another storage device of via the transceiver 150. Execution of the sequences of instructions contained in main memory 140 causes the processor 130 to perform the process steps described herein. In an alternative implementation, hard-wired circuitry may be used in place of or in combination with software instructions to implement the invention. Thus, implementations of the example embodiments are not limited to any specific combination of hardware circuitry and software.

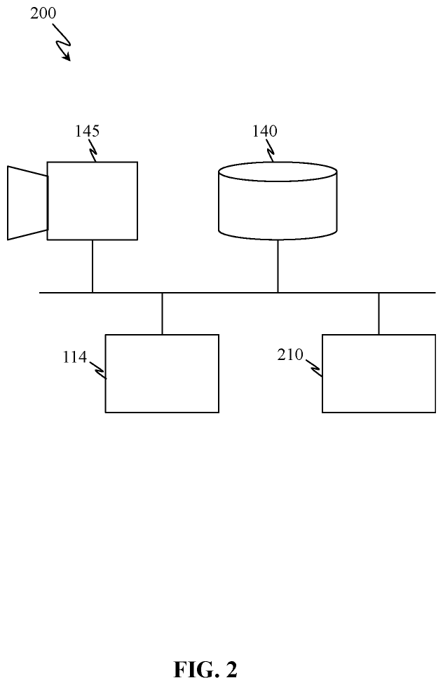

Referring now to FIG. 2, a simplified schematic block diagram is provided illustrating details of the adjustment of the recording modes of driver facing camera system 200 in response to detected driver position, which may be detected via the event detection and reporting system of FIG. 1.

The driver facing camera system 200 includes one or more sensors, devices or systems 114 for providing input data indicative of one or more operating parameters or one or more conditions related to a commercial vehicle and/or drivers and passengers thereof, as discussed with reference to FIG. 1.

The one or more sensors, devices or systems 114 may include sensors, devices or systems configured to detect or otherwise collect driver-related data from which a driver position can be determined, as discussed with reference to FIG. 1. The driver-related data may include driver head position, hand position, location within the vehicle, postural attitude, or the like. Passenger or other occupant data can be similarly detected and collected. It will be understood that, in some embodiments, the sensors, devices or systems 114 may comprise the driver facing camera 145 itself.

The driver facing camera system 200 also includes the memory 140 to which video data captured by the driver facing camera may be recorded. The memory 140 may include a short-term memory, such as a buffer memory, and a long-term memory, such as a disk storage, each of which may comprise one or more distinct physical memories or memory locations within one or more common physical memories. In at least one embodiment, the short-term memory and/or the long-term memory form part of the main memory 140 of the event detection and reporting system 100, but may also be a dedicated memory 140.

The driver facing camera system still further includes a driver-position determination module 210 configured to identify or otherwise determine the driver position from the collected driver-related data. The driver position may include the driver's location within the vehicle (e.g., presence in or out of a seat, location within a bunk area, etc.) and/or the driver's body posture. In at least one embodiment, the driver position includes the driver's presence in or out of the driver seat, and at least one additional characterization. The additional characterization may be, for example, the driver's location in the bunk area, if any, the driver's body posture, or any other characterization of driver position. The driver position may be identified via one or more methodologies, including but not limited to body/posture template matching. The driver-position determination module 210 is further configured to determine, based on the identified driver position, whether the driver position corresponds to a recording-mode-changing event, and to alter the recording mode of the driver facing camera system 200 based on the determination. Accordingly, the driver-position determination module 210 may comprise one or more software modules executed by processor 130, as discussed with reference to FIG. 1. For example, the recording-mode-changing event may be that the driver is out of the driver seat, and at least one additional characterization is satisfied (e.g., the is lying in a bed of the bunk area). As another example, the recording-mode-changing event may be that the driver is in the driver seat, and at least one additional characterization is satisfied (e.g., the driver's body posture indicates drowsiness or some other state).

In at least some embodiments, the at least one additional characterization relates to private conduct of the driver. As used herein, the term “private conduct” refers to conduct for which there is a reasonable expectation of privacy, which includes but is not limited to, non-driving related activities conducted while ‘off the clock,’ such as eating, sleeping, washing, reading a book, watching television, changing clothes, and other such leisure and personal activities. Examples of conduct that is not “private conduct” includes, but is not limited to, activities conducted while ‘on the clock,’ such as eating or using a cell phone while driving or during scheduled driving periods. Thus, otherwise “private conduct” can be categorized as not “private conduct” when done ‘on the clock’ or otherwise in violation of company policies or procedures, laws and/or social norms.

A data bus 220 may communicatively couple the driver position module 210, driver-facing camera 145, sensors 114 and memory 140, as discussed with reference to FIG. 1.

The processor 130 may switch the driver facing camera system 200 between recording modes based on the determination that the identified driver position corresponds to one or more mode-change events. The one or more mode-change events may be stored in the memory 140 for comparison to the driver position by the driver-position determination module. Exemplary mode-change events may include, for example and without limitation, whether the driver seat is occupied/unoccupied, whether the driver's body posture, head and/or hands is in a driving position, etc.

The recording modes may include a normal recording mode, in which unobscured video data from the driver facing camera 145 is recorded by the memory 140, and one or more obscured modes, in which video data of the driver facing camera 145 is altered in some manner which obscures the recorded image data, in whole or in part, or is otherwise not recorded. One or more techniques for altering video data to obscure recorded image data are disclosed in U.S. application Ser. No. 16/664,626, incorporated herein by reference.

In particular, switching to the obscured mode may, as a practical matter, result in the driver not being recorded, in whole or in part. For example, in the obscured mode the video data from the driver facing camera may not be recorded in the long-term memory, but may still allow for the video data to be temporarily recorded to the short-term memory, e.g., the buffer memory. This may allow for the event detection and reporting system to utilize the video data stored in the short-term memory to detect safety events and other vehicle-related events. In particular, this may allow for the driver facing camera to be utilized for the detection of mode change events while in the obscured recording mode.

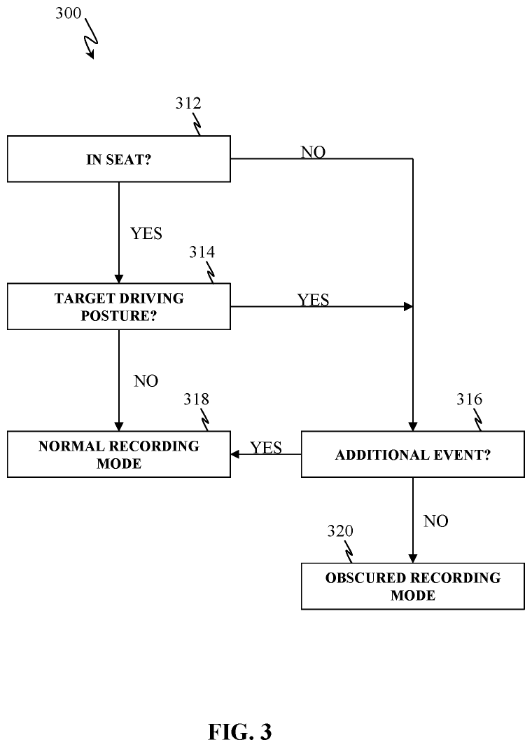

FIGS. 3 illustrates an exemplary process 300 by which the recording mode of the driver-facing camera system 200 may be altered based on the determination of one or more recording-mode-changing events from driver-related data. It should be understood that one or more of the described steps may be omitted, that additional steps may be added, and that the order of steps may be changed, without departing from the principles of the invention disclosed herein.

At Step 312, the driver-position identification module 210 determines whether the identified driver position indicates that the driver is in or out of the driver seat. The determination may be based on driver-related data, including driver-related data from, for example, pressure sensors in the driver seat, the steering wheel, the pedals and/or the floor. The determination may additionally, or alternatively, be based on driver-related data from the driver facing camera 145 (or other cameras facing the cabin or portions thereof).

If the driver-position identification module 210 determines that the driver is in the driver's seat, then the process proceeds to step 314. If not, the process proceeds to Step 320, in which the recording mode is switched to, or maintained at, as the case may be, the obscured recording mode. Alternatively, as shown, the process may proceed to intermediate Step 316.

At Step 314, the driver-position identification module 210 determines whether the identified driver position indicates that the driver (in the driver seat) is in a suitable driving attitude or body posture, or not. Again, the determination may be based on the collected driver-related data, particularly from the driver facing camera 145 (or other cameras facing the cabin or portions thereof). The driver-position identification module 210 may utilize body/posture template matching methodologies to make the determination.

If the driver-position identification module 210 determines that the driver is not in a suitable driving attitude or body posture, then the process proceeds to Step 318, in which the recording mode is switched to, or maintained at, as the case may be, the normal recording mode. This may occur, for example, if the driver in the seat bends down towards the floor, around the seat back, or takes other non-target driving postures for which recording is desired. If the driver-position identification module 210 determines that the driver is in a suitable driving attitude or body posture, then the process proceeds to Step 320, in which the recording mode is switched to, or maintained at, as the case may be, the obscured recording mode. Alternatively, as shown, the process may proceed to intermediate Step 316.

At Step 316, the processor 130 may take additional detected events into consideration, the satisfaction of which cause the processer 130 to alter the recording mode of the driver facing camera 145. In particular, the event detection and reporting system 100 may detect one or more such additional mode-change events based on vehicle-related data, and in response to which the recording mode is switched to, or maintained at, as the case may be, to either the normal 318 or the obscured 320 recording mode. For example, where the driver is identified as either not in the seat or is not in a target driving posture, but the vehicle-related data indicates that the vehicle is moving and not parked, the processor 130, the recording mode may be switched to, or otherwise maintained at, the normal recording mode 318, even though the recording mode may otherwise have been switched to, or maintained at, the obscured recording mode 320. Examples of such additional events that may be considered can be found in U.S. application Ser. No. 16/664,626, incorporated herein by reference

Accordingly, the processor 130 may further switch the driver facing camera system 200 between different recording modes based on the detection of one or more additional mode-change events, which may be determined based on, for example, vehicle state, telematics information, and/or safety events. Exemplary additional mode-change events may include, for example and without limitation, ignition on/off, engine on/off, parking brake engaged/disengaged, gear in driver/park, telematics logged-in/logged-out, etc.

In some embodiments, an audio and/or visual indicator, such as for example, a small light on the dashboard or in the cabin, may also be provided to indicate that normal recording is in progress. Accordingly, the indicator may be operatively coupled to the processor 130 and responsive to processor commands to alter recording modes, or to otherwise turn on/off, in connection with the recording. The principles of the invention may also be applied to audio recordings captured by one or more microphones, independently or in connection with the driver facing cameras 145.

As used herein, the terms “camera” or “cameras” are intended to refer to any and all digital imaging devices, including but not limited to cameras. Moreover, references to “driver,” “passenger,” and “occupant,” should be understood to be interchangeable, and the principles of the invention understood to apply as appropriate to each.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, the invention is described herein with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

The term “server” means a functionally-related group of electrical components, such as a computer system that may or may not be connected to a network and which may include both hardware and software components, or alternatively only the software components that, when executed, carry out certain functions. The “server” may be further integrated with a database management system and one or more associated databases.

In accordance with the descriptions herein, the term “computer readable medium,” as used herein, refers to any non-transitory media that participates in providing instructions to the processor 130 for execution. Such a non-transitory medium may take many forms, including but not limited to volatile and non-volatile media. Non-volatile media includes, for example, optical or magnetic disks. Volatile media includes dynamic memory for example and does not include transitory signals, carrier waves, or the like.

In addition, and further in accordance with the descriptions herein, the term “logic,” as used herein, with respect to FIG. 1, includes hardware, firmware, software in execution on a machine, and/or combinations of each to perform a function(s) or an action(s), and/or to cause a function or action from another logic, method, and/or system. Logic may include a software controlled microprocessor, a discrete logic (e.g., ASIC), an analog circuit, a digital circuit, a programmed logic device, a memory device containing instructions, and so on. Logic may include one or more gates, combinations of gates, or other circuit components.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A system for recording vehicle occupants and their immediate environment, comprising:
a driver-facing camera having a plurality of recording modes;
an input that receives driver-related data; and
a processor configured to determine a driver position within the vehicle, based on the detected driver-related data, and to alter the recording mode of the driver-facing camera in response to the determined driver position, wherein determining the driver position includes determining: a presence of the driver in or out of a driver seat, and an additional characterization of the driver position within the vehicle.

2. The system of claim 1, wherein the driver position includes that the driver is out of the driver seat.

3. The system of claim 1, wherein the at least one additional characterization includes a body posture of the driver.

4. The system of claim 1, wherein the alteration of the recording mode is from an obscured recording mode to a normal recording mode.

5. The system of claim 1, wherein the determined driver position is that the driver is in the driver seat and is not in the target driving posture.

6. The system of claim 4, wherein the obscured recording mode causes video data from the driver-facing camera to not be recorded to a memory where the video data is recorded in the normal recording mode.

7. The system of claim 6, wherein the determined driver position is that a driver is in a driver seat and is not in a target driving posture.

8. The system of claim 2, wherein the at least one additional characterization of the driver position in the vehicle relates to private conduct.

9. The system of claim 1, wherein the processor is configured to alter the recording mode of the driver-facing camera in response to vehicle-related data received by the input, in addition to the determined driver position.

10. A method for recording vehicle occupants and their immediate environment, comprising:
receiving driver-related data;
determining a driver position within the vehicle based on the detected driver-related data; and
altering a recording mode of a driver-facing camera in response to the determined driver position, wherein determining the driver position includes determining: a presence of the driver in or out of a driver seat, and an additional characterization of the driver position within the vehicle.

11. The method of claim 10, wherein the driver position indicates includes that the driver is out of the driver seat.

12. The method of claim 10, wherein the at least one additional characterization includes a body posture of the driver.

13. The method of claim 10, wherein the alteration of the recording mode is from an obscured recording mode to a normal recording mode.

14. The method of claim 10, wherein the determined driver position is that the driver is in the driver seat and is not in the target driving posture.

15. The method of claim 14, wherein the obscured recording mode causes video data from the driver-facing camera to not be recorded to a memory where the video data is recorded in the normal recording mode.

16. The method of claim 15, wherein the determined driver position is that a driver is in a driver seat and is not in a target driving posture.

17. The method of claim 10, wherein the at least one additional characterization of the driver position in the vehicle relates to private conduct.

18. The method of claim 1, further comprising:
receiving vehicle-related data, altering the recording mode of the driver-facing camera is in response to the received vehicle-related data, in addition to the determined driver position.
